(19) United States
(12) Patent Application Publication
(10) Pub. No.: US 2018/0057920 A1
(43) Pub. Date: Mar. 1, 2018

(54) GRAIN REFINEMENT IN IN706 USING LAVES PHASE PRECIPITATION

(71) Applicant: GENERAL ELECTRIC COMPANY, Schenectady, NY (US)

(72) Inventors: Martin Matthew MORRA, Glenville, NY (US); Andrew Joseph DETOR, Albany, NY (US); Etienne MARTIN, Niskayuna, NY (US); Reza SHARGHI-MOSHTAGHIN, Clifton Park, NY (US)

(73) Assignee: GENERAL ELECTRIC COMPANY, Schenectady, NY (US)

(21) Appl. No.: 15/252,783

(22) Filed: Aug. 31, 2016

(51) Int. Cl. C22F 1/10; C22C 19/05; C22C 30/00; F01D 5/28

(52) U.S. Cl. CPC C22F 1/10; C22C 19/056; C22C 30/00; F05D 2240/30; F05D 2300/175; F05D 2300/608; F01D 5/28

(57) ABSTRACT

Provided is a method of fabricating an article, including deforming an ingot of a nickel-based superalloy to form an intermediate article, forming a substantially homogeneous dispersion of Laves phase precipitates within the intermediate article, wherein the Laves phase precipitates are present at a concentration of at least about 0.05% by volume and the precipitates have a mean diameter of less than one micron. Also provided is a nickel-based superalloy including a substantially homogeneous dispersion of Laves phase precipitates, wherein the intergranular and transgranular Laves phase precipitates are present at a concentration of at least about 0.1% by volume and wherein the precipitates have a mean diameter of less than one micron. Precipitation of Laves phase may control microstructure during Thermo-mechanical processing and produce superalloys with refined grain size.

The invention relates generally to alloys for making articles with improved lifespan for use in extreme temperature and physical stress applications such as high efficiency gas turbine engines, and articles made by such methods.

### BACKGROUND

Consistent and prolonged performance of machined parts, including industrial gas turbine engines, come under increasing demands with improvements in high-efficiency structures and components. For example, the life cycle of gas turbine engine shafts, disks, and large wheels, among other components, may be limited by low cycle fatigue in many instances, particularly in regard to prolonged functionality and efficiency at high temperatures. Nickel-based alloys and superalloys generally are attractive constituents for fabricating components of machines where high performance is required for prolonged periods under extreme conditions such as high heat exposure and extreme temperature fluctuations, for a variety of reasons. Alloys containing ultra-fine grain sizes may provide vastly improved fatigue and strength properties. For some alloys, grain size can be substantially reduced using the precipitation of particular intermetallic pinning phases prior to recrystallization and/or grain boundary migration.

Furthermore, large Ni superalloy forgings, in the absence of grain boundary pinning phases, require specific temperatures, strains, and strain rates to achieve grain breakdown and recrystallization to the desired size for required mechanical properties. In very large components, such as industrial gas turbine wheels, these critical processing conditions are not always possible due to the required part size/shape. Current industrial gas turbine wheels experience this problem and thick components have reduced low cycle fatigue lives because grain size is coarse compared to thinner section components where required processing conditions may be attained. Introduction of pinning phases helps in controlling grain size, without having to rely only on thermo-mechanical processing. This would be particularly desirable for very large parts where uniform high strain driving grain refinement and recrystallization cannot be achieved. Improved low cycle fatigue may permit thick section components, such as industrial gas turbine wheels, to be processed with a finer grain size and improved component life

Nickel-based superalloys are alloys based on group VIII elements (nickel, cobalt, or iron) with a higher percentage of nickel compared to any other element to which a multiplicity of alloying elements are added. A defining feature of superalloys is that they demonstrates a combination of relatively high mechanical strength and surface stability at high temperature. Inconel Alloy 706 (IN706) is one example of a nickel-based superalloy known to skilled artisans that is used in a number of gas turbine components and other components exposed to similar extreme temperatures and other harsh conditions. Mechanical properties in use depend both on an alloy's intrinsic characteristics such as chemical composition and on a part's microstructure, grain size in particular. Grain size may govern characteristics such as low-cycle fatigue, strength, and creep. Conventionally, IN706 possesses relatively coarse grains, with grains usually larger than 60 μm in diameter on average after solutionning of a forged part. This is because, conventionally, processing of IN706 does not cause precipitation of second phase particles capable of controlling grain growth during final heat treatment, such as by a grain boundary pinning mechanism. By comparison, in finer-grained alloys where formation of second phase particles is attainable, second phase particles function to pin grain boundaries and thereby reduce grain boundary migration during forging and solution heat treatment.

Thus there is a need for a fabrication method of superalloy components, such as IN706 components, including causing the formation of discrete second phase particles within the superalloy's microstructure. Such a method may advantageously yield a finer and more homogenous grain structure that is attainable with conventional methods.

### SUMMARY

In one aspect, provided is a method of fabricating an article, including deforming an ingot of a nickel-based superalloy to form an intermediate article, forming a substantially homogeneous dispersion of Laves phase precipitates within the intermediate article, wherein the Laves phase precipitates are present in the intermediate article at a concentration of at least about 0.05% by volume and wherein the precipitates have a mean diameter of less than one micron.

Also provided is a nickel-based superalloy including a substantially homogeneous dispersion of Laves phase precipitates, wherein the intergranular and transgranular Laves phase precipitates are present at a concentration of at least about 0.1% by volume and wherein the precipitates have a mean diameter of less than one micron.

### DRAWINGS

These and other features, aspects, and advantages of the present invention will become better understood when the following detailed description is read with reference to the accompanying drawings, wherein:

FIG. 1 is a graph plotting the relationship between Nb content of an IN706 alloy and the low cycle fatigue of an article manufactured therewith.

FIG. 2 shows an example of a method of fabricating an article in accordance with the present invention.

FIG. 3 is a scanning electron micrograph (SEM), with an inset of a transmission electron micrograph (TEM), of an IN706 superalloy possessing Laves phase precipitates in accordance with the present disclosure.

FIG. 4 is diffraction pattern associated with Laves phase precipitated in an IN706 superalloy revealing a hexagonal crystallographic structure in accordance with the present disclosure.

FIG. 5A is an SEM of an IN706 superalloy possessing a relatively high amount of Nb, fine Laves phase particles, and relatively small grain sizes, in accordance with the present disclosure.

FIG. 5B is an SEM of an IN706 superalloy possessing a lower amount of Nb than the IN706 superalloy shown in FIG. 5A, an absence of fine Laves phase particles, and relatively larger grain sizes than the IN706 superalloy shown in FIG. 5A.

FIG. 6A is an SEM of an IN706 superalloy possessing a relatively high amount of Nb after forging then cooling at a rate of 6° C. per minute, resulting in fine Laves phase particles, and relatively small grain sizes, in accordance with the present disclosure.

FIG. 6B is an SEM of an IN706 superalloy possessing the same, relatively high amount of Nb as the IN706 superalloy shown in FIG. 6A, after forging then cooling at a rate of <6° C. per minute, resulting in finer Laves phase particles, and relatively smaller grain sizes, than seen in the IN706 superalloy shown in FIG. 6A, in accordance with the present disclosure.

### DETAILED DESCRIPTION

In an aspect, a method of fabricating an article is provided, including deforming an ingot of a nickel-based superalloy to form an intermediate article, forming a substantially homogeneous dispersion of Laves phase precipitates within the intermediate article, wherein the Laves phase precipitates are present in the intermediate article at a concentration of at least about 0.05% by volume and wherein the precipitates have a mean diameter of less than one micron.

In an example the Laves phase precipitates may be present in the intermediate article at a concentration of at least about 0.075% by volume. In another example, the Laves phase precipitates may be present in the intermediate article at a concentration of at least about 0.1% by volume.

In yet another example, forming a substantially homogeneous dispersion of Laves phase precipitates may include holding a temperature range to which the intermediate article is exposed to a temperature range, such as, for example, between 700° C. and 1000° C., for at least one hour. The intermediate article may be exposed to a temperature range for two hours or longer. In an embodiment, the intermediate article may be cooled at or below a cooling rate such that the intermediate article is exposed to a temperature range of, for example, between 1000° C. and 700° C. for at least one hour, such as for two hours or more in some examples.

Cooling the intermediate article at or below a cooling rate may be accomplished by, for example, contacting a surface of an ingot with an insulating material during forging, contacting the ingot with an insulating material after forging, submerging the ingot in a granular solid insulating material after forging, contacting the ingot with a heated substance after forging, or exposing the intermediate article after forging to an environment heated to within the temperature range. For example, cooling the intermediate article at or below a cooling rate may include exposing the intermediate article after forging to an environment heated to within a desired temperature range.

In some examples, forming may include exposing the intermediate article to a desired temperature range for at least six hours, whereas in some examples it may include exposing the intermediate article to a desired temperature range for ten hours or less.

In yet other examples, deforming an ingot may include forging, extruding, rolling, or drawing. For example, deforming may include forging, wherein forging includes exposing an ingot to a temperature below approximately 1010° C., or extruding, wherein extruding includes exposing an ingot to a temperature above approximately 1010° C.

In yet other examples, a nickel-based superalloy may have a composition comprising at least 20 weight percent iron, between 3.0 weight percent niobium and 3.5 weight percent niobium, below 0.20 weight percent silicon, carbon wherein a weight percent carbon is less than 0.02 percent, between 40 weight percent nickel and 43 weight percent nickel, between 15.5 weight percent chromium and 16.5 weight percent chromium, between 1.5 weight percent titanium and 1.8 weight percent titanium, and between 0.1 weight percent aluminum and 0.3 weight percent aluminum.

In further examples, a nickel-based superalloy may have a composition comprising at least 52 weight percent nickel, between 4.9 weight percent niobium and 5.55 weight percent niobium, less than 0.35 weight percent silicon, carbon wherein a weight percent carbon is less than 0.02 percent, between 17.0 weight percent chromium and 19.0 weight percent chromium, between 16.0 weight percent iron and 20.0 weight percent iron, between 0.75 weight percent titanium and 1.15 weight percent titanium, between 2.8 weight percent molybdenum and 3.3 weight percent molybdenum.

In another aspect, an article is provided, including a nickel-based superalloy with a substantially homogeneous dispersion of Laves phase precipitates, wherein intergranular and transgranular Laves phase precipitates are present at a concentration of at least about 0.1% by volume and wherein the precipitates have a mean diameter of less than one micron.

In some examples, the nickel-based superalloy may have a composition comprising at least 20 weight percent iron, between 3.0 weight percent niobium and 3.5 weight percent niobium, below 0.20 weight percent silicon, carbon wherein a weight percent carbon is less than 0.02 percent, between 40 weight percent nickel and 43 weight percent nickel, between 15.5 weight percent chromium and 16.5 weight percent chromium, between 1.5 weight percent titanium and 1.8 weight percent titanium, and between 0.1 weight percent aluminum and 0.3 weight percent aluminum.

In further examples, a nickel-based superalloy may have a composition comprising at least 52 weight percent nickel, between 4.9 weight percent niobium and 5.55 weight percent niobium, less than 0.35 weight percent silicon, carbon wherein a weight percent carbon is less than 0.02 percent, between 17.0 weight percent chromium and 19.0 weight percent chromium, between 16.0 weight percent iron and 20.0 weight percent chromium, between 0.75 weight percent titanium and 1.15 weight percent titanium, and between 2.8 weight percent molybdenum and 3.3 weight percent molybdenum.

In some examples, the article may include a part for a gas turbine engine, such as a turbine disk or other part.

Each embodiment presented below facilitates the explanation of certain aspects of the disclosure, and should not be interpreted as limiting the scope of the disclosure. Moreover, approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value. When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. Any examples of operating parameters are not exclusive of other parameters of the disclosed embodiments. Components, aspects, features, configurations, arrangements, uses and the like described, illustrated or otherwise disclosed herein with respect to any particular embodiment may similarly be applied to any other embodiment disclosed herein.

This disclosure provides a fabrication method for nickel-based superalloys that makes it possible to limit the appearance of coarse grains during fabrication of machine parts, such as for gas turbine engines, by introducing fine (<1 μm) discrete Laves phase particles with spherical shape within the microstructure of the superalloy. To obtain fine laves phase particles, the allowable chemistry window may be reduced. Niobium may be present at equal to or greater than 3 weight percent. Silicon may be present at below 0.2 weight percent. For example, silicon may be present at between 0.01 and 0.2 weight percent, 0.03 and 0.2 weight percent, or 0.05 to 0.2 weight percent. In other examples, silicon may be present at less than 0.35 weight percent. Carbon level may also be kept below 0.02 weight percent. In some examples, an ingot of nickel-based is forged at a temperature below 1010° C., although other well-known processes for deforming an ingot may also be employed such as extruding, rolling or drawing. Furthermore, a cooling rate after ingot deformation may be slowed, permitting the formation of Laves phase precipitates. A cooling rate may be, for example, less than 10° C./min. A nickel-based superalloy article thereby manufactured possesses reduced grain size.

As one example, IN706 is a nickel-based superalloy well known to skilled artisans with desirable characteristics and affordability for use in high-efficiency gas turbines, including industrial gas turbines, and other machines. See Schilke & Schwant (1994), Alloy 706 Metallurgy and Turbine Wheel Application, in Superalloys 718, 625, 706 and Various Derivatives, Loria, Ed., The Minerals, Metals & Materials Society, pp 1-12; U.S. Pat. No. 3,663,213. IN706 alloys may possess various chemical constituents within a range of concentrations while still being considered characteristic of IN706. For example, IN706 may conventionally contain approximately at least 20 weight percent iron, between 2.8 weight percent niobium and 3.5 weight percent niobium, below 0.1 weight percent silicon, carbon wherein a weight percent carbon is less than 0.02 percent, between 40 weight percent nickel and 43 weight percent nickel, between 15.5 weight percent chromium and 16.5 weight percent chromium, and between 1.5 weight percent titanium and 1.8 weight percent titanium, among other constituents. Related alloys, such as Inconel Alloys 600, 718, and 625, which are also well known to skilled artisans, also contain some or all of these constituent elements, although one or more being in different weight percentages than their weight percentages in IN706, and modifications thereof that possess characteristics of alloys and processing steps thereof as explained below are included within the present disclosure.

Second phase precipitates, in some metal alloys and superalloys, have been shown to constrain grain boundary migration and corresponding grain size, resulting in articles made therewith possessing improved qualities related to, for example, resistance to cracking and repeated exposure to high temperature stress and other physical stresses, particularly in large parts and parts subjected to prolonged and strong centrifugal forces. However, prior attempts to effect such reduced grain size using second phase particles in IN706 alloys has been notoriously difficult by conventional metallurgical processes. Conventionally, formation of Laves phase in IN706 and some other related alloys, sometimes referred to as freckling, is discouraged, with Laves phase precipitates considered defects and to confer disadvantageous properties on a resulting alloy such as an IN706 alloy. Conventionally, such Laves phase precipitates are coarse (>1 μm) and have a cuboidal shape with straight edges. They also tend to be heterogeneously distributed and localized mostly at grain boundaries. These conventionally coarse (>1 um) blocky, globular, cuboidal or non-curved Laves phase particles, heterogeneously distributed along grain boundaries, are disadvantageous, resulting in embrittlement of the material and thus reduces ductility and increased susceptibility to cracking. See Thamboo (1994) Melt Related Defects In Alloy 706 And Their Effects on Mechanical Properties, in Superalloys 718, 625, 706 and Various Derivatives, Loria, Ed., The Minerals, Metals & Materials Society, pp 137-152. Laves phase precipitates do not contribute significantly to the strength of the alloy and in fact compete for the elements forming the hardening gamma double prime precipitate. Because of this, literature conventionally supports the conclusion that Laves phase formation should be avoided.

Disclosed herein is a type of alloy such as IN706 and a method of thermomechanical processing thereof that results in manufacture of an article with desirably reduced grain size, accompanied by precipitates including Laves phase precipitation in the alloy's microstructure, and components manufactured in accordance with such a method. In accordance with the present disclosure, advantageous Laves phase precipitates may be homogeneously distributed, and may be distributed inter- and trans-granularly and their shape may be more spherical with curved edges, and they may be finer in size (<1 μm), in comparison to conventional precipitates. In some examples in accordance with the present disclosure, Laves phase particles may have a mean diameter of less than one micron. For example, Laves phase particles may have a mean diameter of 650 nm±200 standard error of the mean (SEM), or of 650 nm±500 nm SEM. The beneficial effects of Laves phase precipitation formed in accordance with the present disclosure are particularly surprising in view of conventional teaching that its formation is disadvantageous, and in view of the widely known difficulty of constraining grain boundary migration and grain size in some superalloys, such as IN706.

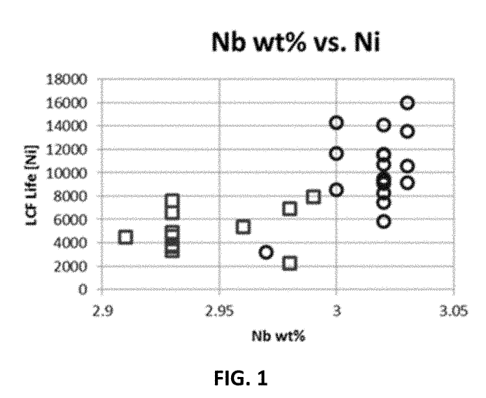

Given ranges of concentration of different constituent elements that may be present in an IN706 alloy or other alloy, there is generally some variability in the chemistry of IN706 alloys and articles made thereof, depending on a given supplier or lot. Correspondingly, there may also be differences in resiliency of different alloys, such as resistance to cracking or low cycle fatigue differences. Shown in FIG. 1 is a comparison of low cycle fatigue of articles manufactured from different samples of IN706 alloys. The Y axis shows the number of cycles of applied stress before a crack appeared in the article. Lower numbers of cycles to cracking indicating articles with a shorter lifecycle. As can be seen there is variability between different samples, from approximately 3,000 to 16,000 cycles to crack formation.

Continuing with FIG. 1, the X axis shows the weight concentration of Nb in each sample. As can be seen, there is a range of Nb percent weight composition between samples from approximately 2.91% to approximately 3.03%. (Circular plots and square plots represent samples obtained from different suppliers.) As can be seen, higher percent weight composition of Nb generally corresponds with higher resistance to cracking. In other experiments (data not shown), higher concentrations of Nb in IN706 alloys also generally corresponded to increases cracking resistance (i.e., low cycle fatigue) in thicker samples. Resistance to cracking and improved low cycle fatigue generally is desirable because it allows for the creation of components that can withstand greater temperature and other physical stresses such as prolonged and high centrifugal forces for longer periods of time and more repeatedly, corresponding to longer component service life, as well as the construction of more efficient engines and their components at greater affordability and with improved service profiles. In addition to such desirous effects attained with higher concentrations of Nb, higher weight percentages of Si also corresponded to such effects. In some, non-limiting examples, a Si weight percentage of between approximately 0.05%-0.1% corresponded to improved low cycle fatigue.

Niobium naturally ties up with carbon and nickel to form carbides and gamma double prime in IN706. However, when the amount of Nb that can be dissolved by these two phases is exceeded, the gamma matrix becomes supersaturated with Nb which favors the formation of Laves phase. Nb also tends to segregate at grain boundaries, which decreases the recovery kinetics. Consequently, at high Nb concentrations, such as those that are shown here to lead to improved low cycle fatigue, fine spherical Laves phase formation is accelerated due to the higher energy stored during hot working. As disclosed herein, under certain conditions, high Nb concentrations may promote formation of fine grain sizes as a result of promoting fine spherical Laves phase precipitates. Likewise, Si also promotes fine spherical Laves phase precipitation. It reduces the solubility of Nb in gamma and thus the standard free energy of the fine spherical Laves phase precipitation. For these reasons, promotion of fine grain size may result from high levels of Nb and Si, with typical ranges of IN706 and related alloys, in accordance with the present disclosure. Carbon concentration may also be kept low, also promoting fine spherical Laves phase precipitation and fine rain size.

As disclosed herein, unexpectedly in view of this notorious difficulty in attaining grain size refinement in IN706 and the widely held belief that Laves phase precipitation is disadvantageous, grain size refinement can be achieved through precipitation of a fine spherical Laves phase prior to recrystallization and/or grain boundary migration during hot working. Laves phase in IN706 is a hexagonal (Fe, Ni, Si)₂ (Nb, Ti) phase which may typically be precipitated after long time exposure at temperatures below 1010° C. For example, during forging an ingot may be exposed to a temperature between 700° C.-1010° C. A temperature of between 800° C.-1000° C., or between 850° C.-950° C. may also be employed. In some examples, a temperature of between 871° C.-927 C° may be used. Since Laves phase remains stable at solution temperature (such as between approximately 950° C.-1000° C.), it can be used to reduce recrystallization (dynamic and static) grain size by reducing the migration of grain boundaries after deformation.

As disclosed herein, if fine spherical Laves phase is forced to precipitate during hot working, with elemental constituents as disclosed herein, it may be produced in a uniform dispersion throughout the matrix, appearing metallographically as generally spheroidal particles 0.5 to 1 microns in size. If the alloy is then recrystallized with the uniform dispersion of fine spheroidal Laves phase present, the newly formed grain boundaries incorporate the Laves phase, effectively inhibiting grain growth. The result is a much finer, more uniform grain size than that achieved by conventional processing.

Also in accordance with the present disclosure, under the aforementioned forging conditions and alloy chemistry, Laves phase precipitation results from employing a slowed cooling rate after thermomechanical processing. As disclosed herein, slowing cooling, such as by contacting a surface of or covering an ingot with an insulating material during and after forging, or simply after forging (such as para-aramid fiber blankets or other thermally protective coverings), submerging the ingot in a granular solid insulating material after forging, contacting the ingot with a heated substance after forging such as a heating element, or holding it in a heated environment such as a furnace or other heated environment for a desired duration at a controlled or otherwise elevated temperature, advantageously promotes Laves phase formation. After thermomechanical processing (e.g., forging, extruding, rolling, drawing, or other means of deformation under temperature conditions used in hot working of superalloys) exposing an article to a temperature of between 700° C.-1000° C., or slowing the cooling of the article such that is remains exposed to a temperature within such range for some prolonged duration of time after hot working, advantageously promotes Laves phase formation. For example, by maintaining such temperature or slowing the rate of cooling, an article may be exposed to a temperature with such range for one hour or more, two hours or more, three hours or more, four hours or more, five hours or more, or six hours or more, seven hours or more, eight hours or more, nine hours or more, or ten hours or more, thereby advantageously promoting fine spherical Laves phase precipitation, in accordance with the present disclosure.

During a post-hot working period of slowed cooling or prolonged exposure to an elevated temperature, a rate of cooling may be slowed to less than 6° C./minute. For example, it may be slowed to less than 1° C., less than 2° C., less than 3° C., less than 4° C., less than 5° C., or less than 6° C. per minute. Slowing a cooling rate is one example disclosed herein of a method for promoting fine spherical Laves phase formation. Faster but still reduced cooling rates may also be employed, such as slower that 7° C., slower than 8° C., slower than 9° C., and slower than 10° C. per minute. Maintaining an elevated temperature (meaning above ambient or room temperature within the ranges disclosed above) and/or slowing a cooling temperature to maintain an elevated temperature, according to the non-limiting examples disclosed herein represent different variations of embodiments presently described.

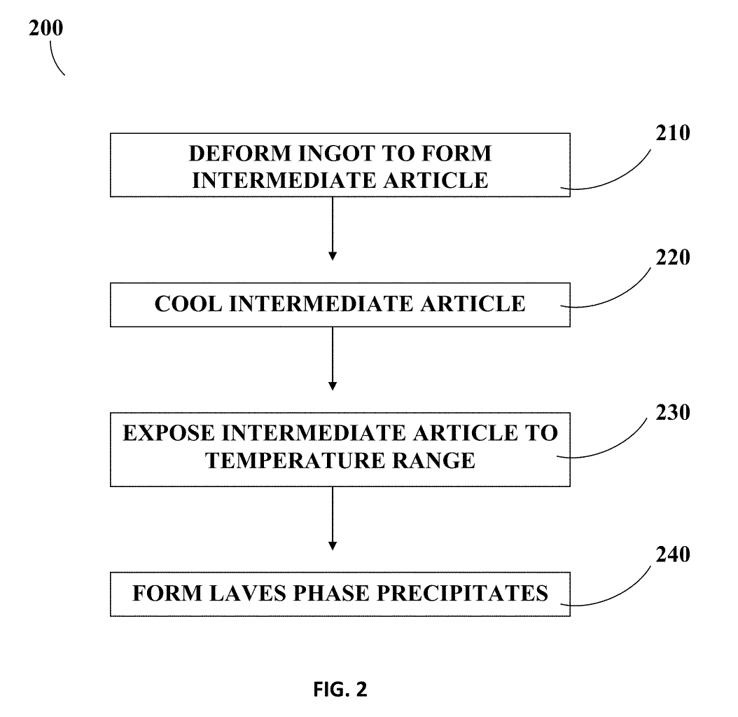

An example of a method in accordance with the present disclosure is shown in FIG. 2. A non-limiting example of a method 200 is shown. Method 200 includes deforming an ingot to form an intermediate article 210, such as thermomechanical processing methods including forging, extruding, rolling, and drawing. The article may be a nickel-containing superalloy, including IN706, with Nb levels between 3%-3.5% weight Nb and 0.05%-0.1% weight Si. In one example, deforming 210 may include forging, including exposing an ingot to a temperature below approximately 1010° C., or extruding including exposing the ingot to a temperature above approximately 1010° C. After deforming 210 method 200 may include, for example, cooling the intermediate article 220. Cooling 220 generally refers to any method for exposing the article to a temperature lower than a temperature at which it was deformed 210. For example, cooling 220 can result from loss of heat from the article to the ambient environment which is at a lower temperature than a temperature at which deforming 210 occurred. Cooling 220 may include or be followed by exposing the intermediate article to temperature range 230. A temperature range during such exposure 230 may generally be within the ranges disclosed above for promoting formation of Laves phase 240. In some examples, exposure to a temperature range 230 may occur without initially cooling the article 220. For example, the article may initially be maintained, for some brief period of time, at a temperature to which it was exposed during deforming 210. Or cooling 220 may occur intermittently between alternating periods, or in alternation with a period, during which the article is maintained at a given temperature within a range without cooling during such period. Cooling 220 may occur at slowed rates such as the ranges of rates of cooling described above and exposure to a temperature 230 may occur within temperature ranges and duration of time described above.

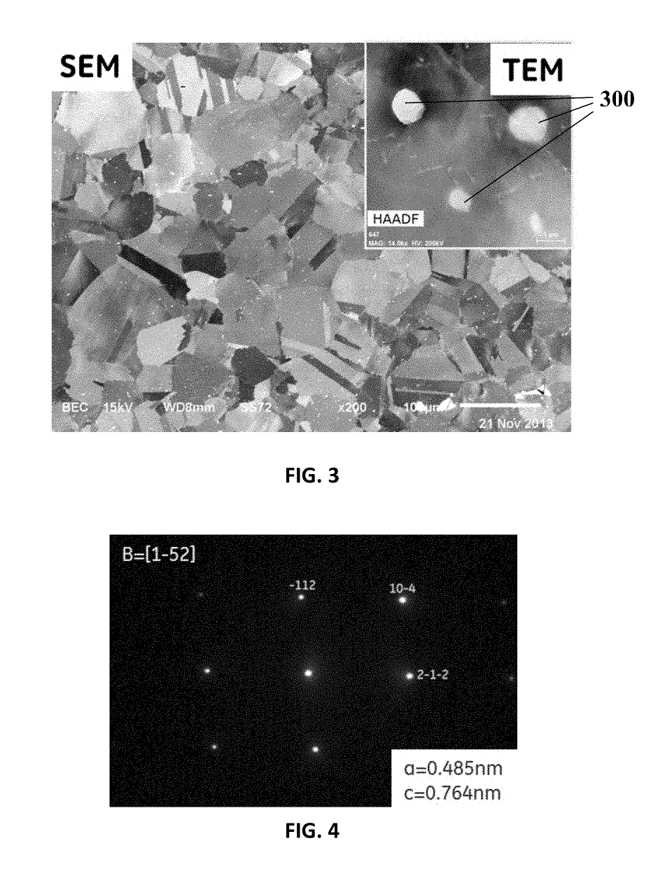

An example of an article made with an IN706 alloy in a method in accordance with the present disclosure is shown in FIG. 3. FIG. 3 is an SEM image showing fine spherical Laves phase randomly dispersed within an IN706 microstructure after forging and heat treatment. A TEM image (inset) shows that the size of Laves phase precipitates 300 is approximately 0.5-1 μm. In FIG. 4, a diffraction pattern of precipitates 300 is shown, revealing a diffraction pattern known to be associated with Laves phase, revealing a hexagonal crystallographic structure (c/a ratio=1.58).

FIG. 5A and FIG. 5B show differences in grain size in IN706 articles containing Nb levels in accordance with the present invention (FIG. 5A, >3% weight Nb) and with lower Nb levels (FIG. 5B, <3% Nb weight). Higher Nb levels and Laves phase precipitation in this example lead to smaller grain size (53 μm diameter average) than lower Nb levels where Laves phase precipitates were not observed (125 μm average grain diameter). That is, in this example, Laves phase precipitation in accordance with the present invention was associated with a more than 55% decrease in grain size.

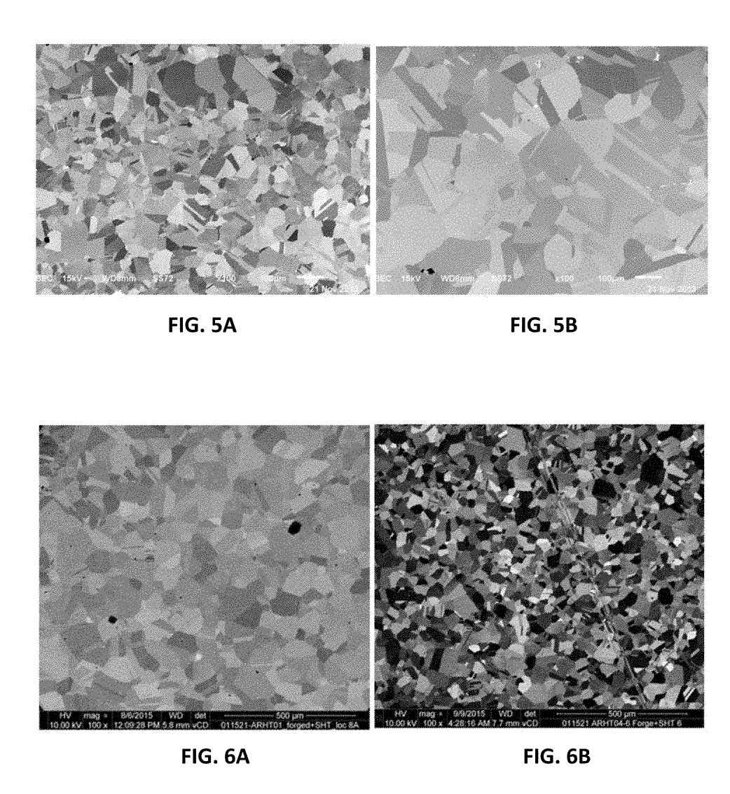

Comparing FIG. 6A to FIG. 6B reveals the effect of slowing cooling rate after deformation/thermomechanical processing may have on grain size in accordance with the present disclosure. Both show IN706 alloys with higher Nb levels and moderate-to-low Si levels (3.2 wt % Nb, 0.08 wt % Si and 0.005 wt % C). In FIG. 6A after thermomechanical processing the articles was cooled at a rate of 6° C./min. After solution treatment (982° C./1 hr.), average resulting grain size was 78 μm in diameter. When the cooling rate is slowed down as shown to slower than 6° C./min as shown in FIG. 6B, grain growth during solution was reduced leading to an average grain diameter of 43 μm. If the fine spherical Laves phase is forced to precipitate during thermomechanical treatment, it may be produced in a uniform dispersion throughout the matrix, appearing metallographically as generally spheroidal particles 0.5 to 1 microns in size. Fine spherical Laves phase precipitates may also form homogeneously or substantially homogeneously throughout the article. For example, fine spherical Laves phase precipitates may constitute at least about 0.05% by volume of any portion of an article tested, rather than low Laves phase and larger grain sizes in some portions of the article than other, increasing uniformity in characteristics of a component throughout its physical structure. In other examples, fine spherical Laves phase precipitates may constitute at least about 0.075% by volume of any portion of an article tested, or 0.1% by volume of any portion of an article tested.

An article made by a foregoing method is also disclosed herein. A nickel-based superalloy including a substantially homogeneous dispersion of intergranular and transgranular Laves phase precipitates may be formed, wherein the intergranular and transgranular Laves phase precipitates may be present at a concentration of at least about 0.1% by volume and wherein the precipitates have a mean diameter of less than one micron (including, as non-limiting examples, a mean diameter of 650 nm±200 nm SEM or a mean diameter of 650 nm±500 nm SEM). The nickel-based superalloy may have a composition comprising at least 20 weight percent iron, between 3 weight percent niobium and 3.5 weight percent niobium, below 0.2 weight percent silicon (including, as non-limiting examples, at least 0.01, 0.03, or 0.05 weight percent silicon up to 0.1 or 0.2 weight percent silicon), carbon wherein a weight percent carbon is less than 0.02 percent, between 40 weight percent nickel and 43 weight percent nickel, between 15.5 weight percent chromium and 16.5 weight percent chromium, and between 1.5 weight percent titanium and 1.8 weight percent titanium.

The article may, for example, be a nickel-based superalloy with a composition of at least 53 weight percent Nickel, between 4.9 weight percent niobium and 5.2 weight percent niobium, between 0.01 weight percent silicon and 0.1 weight percent silicon, and carbon wherein a weight percent carbon is less than 0.2 percent. In some examples, an article is a part for a gas turbine engine. In further examples, an article may be a turbine blade.

It is to be understood that the above description is intended to be illustrative, and not restrictive. Numerous changes and modifications may be made herein by one of ordinary skill in the art without departing from the general spirit and scope of the invention as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Also, the term “operably” in conjunction with terms such as coupled, connected, joined, sealed or the like is used herein to refer to both connections resulting from separate, distinct components being directly or indirectly coupled and components being integrally formed (i.e., one-piece, integral or monolithic). Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of fabricating an article, the method comprising:
deforming an ingot comprising a nickel-based superalloy to form an intermediate article;
forming a substantially homogeneous dispersion of Laves phase precipitates within the intermediate article, wherein the Laves phase precipitates are present in the intermediate article at a concentration of at least about 0.05% by volume and wherein the precipitates have a mean diameter of less than one micron.

2. The method of claim 1, wherein the Laves phase precipitates are present in the intermediate article at a concentration of at least about 0.075% by volume.

3. The method of claim 2, wherein the Laves phase precipitates are present in the intermediate article at a concentration of at least about 0.1% by volume.

4. The method of claim 1, wherein forming comprises holding a temperature range to which the intermediate article is exposed to between 700° C. and 1000° C. for at least one hour.

5. The method of claim 1, wherein forming comprises cooling the intermediate article at or below a cooling rate such that the intermediate article is exposed to a temperature range of between 1000° C. and 700° C. for at least one hour.

6. The method of claim 5, wherein cooling the intermediate article at or below a cooling rate comprises contacting a surface of the ingot with an insulating material during forging, contacting the ingot with an insulating material after forging, submerging the ingot in a granular solid insulating material after forging, contacting the ingot with a heated substance after forging, or exposing the intermediate article after forging to an environment heated to within the temperature range.

7. The method of claim 3, wherein forming comprises exposing the intermediate article to the temperature range for at least two hours.

8. The method of claim 7, wherein cooling the intermediate article at or below a cooling rate comprises exposing the intermediate article after forging to an environment heated to within the temperature range.

9. The method of claim 7, wherein forming comprises exposing the intermediate article to the temperature range for at least six hours.

10. The method of claim 4, wherein forming comprises exposing the intermediate article to the temperature range for ten hours or less.

11. The method of claim 1, wherein deforming comprises forging, extruding, rolling, or drawing.

12. The method of claim 1, wherein the nickel-based superalloy has a composition comprising at least 20 weight percent iron, between 3.0 weight percent niobium and 3.5 weight percent niobium, below 0.20 weight percent silicon, carbon wherein a weight percent carbon is less than 0.02 percent, between 40 weight percent nickel and 43 weight percent nickel, between 15.5 weight percent chromium and 16.5 weight percent chromium, between 1.5 weight percent titanium and 1.8 weight percent titanium, and between 0.1 weight percent aluminum and 0.3 weight percent aluminum.

13. The method of claim 1, wherein the nickel-based superalloy has a composition comprising at least 52 weight percent nickel, between 4.9 weight percent niobium and 5.55 weight percent niobium, less than 0.35 weight percent silicon, carbon wherein a weight percent carbon is less than 0.02 percent, between 17.0 weight percent chromium and 19.0 weight percent chromium, between 16.0 weight percent iron and 20.0 weight percent iron, between 0.75 weight percent titanium and 1.15 weight percent titanium, and between 2.8 weight percent molybdenum and 3.3 weight percent molybdenum.

14. The method of claim 12, wherein deforming comprises forging and forging comprises exposing the ingot to a temperature below approximately 1010° C.

15. The method of claim 12, wherein deforming comprises extruding and extruding comprises exposing the ingot to a temperature above approximately 1010° C.

16. An article comprising:
a nickel-based superalloy including a substantially homogeneous dispersion of intergranular and transgranular Laves phase precipitates, wherein the intergranular and transgranular Laves phase precipitates are present at a concentration of at least about 0.1% by volume through any portion of the article and wherein the precipitates have a mean diameter of less than one micron.

17. The article of claim 16, wherein the nickel-based superalloy has a composition comprising at least 20 weight percent iron, between 3.0 weight percent niobium and 3.5 weight percent niobium, below 0.20 weight percent silicon, carbon wherein a weight percent carbon is less than 0.02 percent, between 40 weight percent nickel and 43 weight percent nickel, between 15.5 weight percent chromium and 16.5 weight percent chromium, between 1.5 weight percent titanium and 1.8 weight percent titanium, and between 0.1 weight percent aluminum and 0.3 weight percent aluminum.

18. The article of claim 16, wherein the nickel-based superalloy has a composition comprising at least 52 weight percent nickel, between 4.9 weight percent niobium and 5.55 weight percent niobium, less than 0.35 weight percent silicon, carbon wherein a weight percent carbon is less than 0.02 percent, between 17.0 weight percent chromium and 19.0 weight percent chromium, between 16.0 weight percent iron and 20.0 weight percent chromium, between 0.75 weight percent titanium and 1.15 weight percent titanium, and between 2.8 weight percent molybdenum and 3.3 weight percent molybdenum.

19. The article of claim 16 comprising a part for a gas turbine engine.

20. The article of claim 19, wherein the part comprises a turbine disk.
